(19) United States
(12) Patent Application Publication
(10) Pub. No.: US 2016/0365193 A1
(43) Pub. Date: Dec. 15, 2016

(54) INDUCTOR

(71) Applicant: HÖGANÄS AB (PUBL), Höganäs (SE)

(72) Inventor: Fredrik AF EKSTRÕM, Mjöhult (SE)

(73) Assignee: HÖGANÄS AB (PUBL), Höganäs (SE)

(21) Appl. No.: 15/121,543

(22) PCT Filed: Feb. 25, 2015
(86) PCT No.: PCT/EP2015/053895

§ 371 Date: Aug. 25, 2016

(30) Foreign Application Priority Data
Feb. 25, 2014 (EP) 14156559.8
Dec. 5, 2014 (EP) 14196583.0

(51) Int. Cl. H01F 27/34; H01F 27/04; H01F 27/06; H01F 27/02

(52) U.S. Cl. CPC H01F 27/346; H01F 27/025; H01F 27/04; H01F 27/06

(57) ABSTRACT

The present disclosure relates to an inductor comprising a coil and a side wall. The side wall surrounds the coil, and comprises an outer portion of an inductor core and/or a shielding sleeve. The side wall comprises an opening providing an electrical connection of the coil. The opening is covered by a filling material, which fills the opening except for where the electrical connection passes.

### TECHNICAL FIELD

The present invention relates to inductors.

### BACKGROUND

Inductors, sometimes also referred to as reactors or chokes, are used in a wide array of applications such as signal processing, noise filtering, power generation, electrical transmission systems etc. In order to provide more compact and more efficient inductors, the electrically conducting winding or coil of the inductor may be arranged around an elongated magnetically conducting core, i.e. an inductor core. An inductor core is preferably made of a material presenting a higher permeability than air wherein the inductor core may enable an inductor of increased inductance.

Inductor cores are available in a large variety of designs and materials, each having their specific advantages and disadvantages. In many inductors, the inductor core comprises an inner core portion surrounded by the coil and an outer core portion surrounding the coil and defining an outer surface of the inductor core. One such type of inductors is the so-called pot core inductor.

In view of the ever increasing demand for inductors in different applications there is still a need for inductors having a flexible and efficient design and which are usable in a wide range of applications.

In order to provide a low-reluctance magnetic flux path, inductor cores are usually made of materials having a high magnetic permeability. However, such materials may easily become saturated, especially at higher magnetomotive force (MMF). Upon saturation, the inductance of the inductor may decrease wherein the range of currents for which the inductor core is usable is reduced. A known measure to improve the usable range is to arrange a magnetic flux barrier e.g. in the form of an air gap, in the part of the core about which the winding is arranged. A properly arranged air gap results in a reduced maximum inductance. It also reduces the inductance sensitivity to current variations. The properties of the inductor may be tailored by using air gaps of different widths.

Another problem arising from inductors is the leakage of magnetic field outside the inductor. Such magnetic fields may affect the performance of or even damage other components in the vicinity of the inductor. Moreover, they may induce eddy currents in surrounding materials, e.g. by coupling to other magnetic structures as e.g. chassis steel plates or similar encasings close to the inductor, thus causing heat to be generated in other components. Again, this may negatively affect the performance or even damage other components. The leakage of time varying magnetic fields outside the inductor may result in different effects, depending on the development of eddy currents and depending on whether the structure is magnetically conductive and causes a coupling to the surrounding structures.

In many applications it is thus desirable to provide shielding of the magnetic field generated by the inductor. Yet another problem of inductors may be the heat generated in the inductor which may increase the copper losses in the coil. In particular, an increase of the temperature of the coil causes an increase of the resistivity of the wire resulting in higher losses. It is beneficial to keep the coil and winding at a low temperature since the coil may often be designed such that the maximum losses are, for example, approximately equally divided between core-losses and winding losses, and at least a major part of the maximum losses are associated with the wire when the inductor current is high.

US 2012/0299678 discloses a reactor including a case made of aluminum and having a box-lid-like shape where the outer surface of the case has a heat radiation structure. The case and the lid are made of aluminum and therefore also function as shields for electromagnetic interference.

Nevertheless it remains desirable to provide improved inductors that are flexible and easy to manufacture.

Small, efficient inductors in particular may show higher temperatures since the temperature level is ruled by the ratio of losses to the outer surface area of the structure. Assuming constant loss levels, a smaller inductor will show higher surface temperatures. The temperature classification of the inductor structure defines the practical limits of allowable temperatures to e.g. fulfill safety aspects and standards for insulation materials. A small, high temperature inductor design thus requires costly materials to fulfill high temperature requirements. It is of general interest to keep the active material volume of the inductor small but also to be able to present an industrially and commercially beneficial product at low cost.

Sometimes inductors are used in an unfriendly environment. It may then be desirable to provide inductors being able to withstand such an environment.

### SUMMARY

The object of the present disclosure is to overcome or ameliorate at least one of the disadvantages of the prior art, or to provide a useful alternative.

The object above may be achieved by the subject-matter of claim 1. Embodiments are set forth in the appended dependent claims, in the following description and in the drawings.

Thus, in a first aspect of the present invention there is provided an inductor comprising a coil and a side wall. The side wall surrounds the coil. The side wall comprises an outer portion of an inductor core and/or a shielding sleeve. The side wall comprises an opening providing an electrical connection of the coil. The opening is covered by a filling material, which fills the opening except for where the electrical connection passes.

The inductor core may comprise an inner portion and an outer portion. The inner portion is surrounded by the coil. The outer portion partly or completely surrounds the coil and defines an outer surface of the inductor core. If the inductor comprises a shielding sleeve, the sleeve is arranged such that it partly or completely surrounds the outer portion of the inductor core. Hence, if seen in an axial cross-section, the sleeve surrounds the outer portion of the inductor core, which surrounds the coil, which surrounds the inner portion of the inductor core.

The side wall of the inductor as described herein may comprise only an outer portion of the core, the outer portion in that case forming an outer side surface of the inductor. As an alternative, the inductor as described herein may comprise both the outer portion of the inductor core and the sleeve, the sleeve in that case forming the outer side surface of the inductor. The sleeve may be arranged such that an inner surface of the sleeve is in contact with the outer surface of the outer portion of the core. The sleeve may have a tubular shape, which is easy to extrude, e.g. in aluminum. The sleeve may provide shielding of the magnetic field generated by the inductor. The sleeve may help to dissipate heat generated in the inductor.

The coil is connected to one or more electrical components exterior of the inductor core, e.g. by means of electrical wires, e.g. two electrical wires, going to and from the coil. The opening allows the electrical connection, e.g. the wires, to be led through the side wall of the inductor. The filling material is arranged in the opening such that the filling material fills the opening, except for where the electrical connection passes through the filling material.

The filling material defines an outer surface of the opening. The surface may be substantially aligned with the outer side surface of the side wall, e.g. following the shape of the outer side surface. Since the opening is covered by the filling material, a seal of the inductor is provided. Preferably, the filling material completely covers the surface of the opening, except for where the electrical connection passes. Preferably the seal is sufficiently tight to be weather proof. Thereby the coil is protected from the external environment and the inductor is able to withstand an unfriendly environment, e.g. an outdoor environment.

The opening covered by filling material may be provided in the most external part of the side wall, e.g. only in the sleeve. However, in case the side wall comprises both the outer portion and the sleeve, an opening covered by the filling material may be provided in either of the outer portion or the sleeve, or they may both have an opening covered by the filling material. In that case, the outer portion and the sleeve preferably have openings at corresponding positions.

There may be one, two, three, four or more openings covered by filling material. If there is a plurality of openings, one of the openings may be used to provide the electrical connection to the coil and the other openings may be completely covered by the filling material, such that a tight seal of the inductor is provided.

The opening comprised in the side wall may comprise, or be constituted by, a slot extending in an axial direction of the side wall. The axial direction of the side wall coincides with that of the inductor. The slot may have its main extension in the axial direction, i.e. it has a longer extension in the axial direction than in a tangential direction.

The slot may extend along a length corresponding to at least 50% of an axial length of the side wall, preferably at least 75% of the axial length of the side wall, more preferably substantially the axial length of the side wall, most preferably the entire axial length of the side wall. The axial length of the side wall is length in the axial direction of the side wall.

In case the slot extends along the entire axial length of the side wall, the side wall, e.g. the sleeve, may have the same cross-sectional shape along its axial length, thus making is suitably for manufacturing by extrusion. The slot may also be useful when mounting the side wall around the coil, as is exemplified below.

The filling material may be elastic. The filling material may comprise a polymer or a mixture of polymers, e.g. rubber, silicone and/or polyurethane. This will help to provide a tight seal of the inductor. Purely as an example, the filling material may be a pliable, elastic element adapted to be press-fit into the opening. The elastic element may first be provided with the electrical connection and thereafter press-fitted into position.

The filling material may be a curable material, which is filled into the opening and then cured. Such material may even be provided so as to fill all voids between the inductor components inside the sleeve so as to reduce the effect of vibrations.

The filling material may define a generally planar outer surface. The planar surface is useful when mounting the inductor to an external mounting surface, which is also generally planar.

The outer surface of the filling material may comprise a groove or other feature for receiving a gasket. Alternatively or additionally, the outer surface of the filling material may itself function as a sealing element, e.g. by utilizing its elastic properties. The outer surface of the filling material may be provided with a protrusion. Yet alternatively, the outer surface of the filling material may be planar and the gasket may be placed between the mounting surface and the outer surface of the filling material.

If utilizing both a sleeve and an outer portion of the inductor core, the sleeve may be arranged to surround the outer core, preferably an inner surface of the sleeve being in contact with an outer surface of the inductor core. The contact improves heat dissipation.

The sleeve may comprise heat dissipation structures extending from an outer surface of the sleeve. The heat dissipation structures may extend in an axial direction of the sleeve, preferably substantially along an axial length of the sleeve, more preferably along the entire axial length of the sleeve.

An outer surface of the side wall may comprise a planar section defining a mounting surface. The planar section of the side wall may be adjacent to the opening filled with the filling material, e.g. at both sides of the opening. In that case, the filling material preferably also forms a planar section, being flush with, or substantially flush with, the outer surface of the side wall.

The side wall may comprise one or more mounting elements for mounting the inductor to an external object. The mounting elements may comprise one or more axial channels for receiving a bolt. As an alternative, or a complement, the mounting elements may comprise one or more axially extending, laterally open channels.

In case the opening is comprised in the sleeve, the sleeve may comprise at least one under-cut or groove for receiving a gasket, preferably the under-cut or groove being located in close proximity to the opening. The under-cut or groove may surround the opening, or in case the opening extends over the entire axial length of the side wall, there may be an under-cut or groove at either side of the opening. This gasket may be utilized as an alternative to, or complement to, utilizing the gasket described above or to utilizing the filling material itself as a gasket.

The inductor may comprise at least one end plate mountable to an end of the sleeve so as to close said end, wherein the end plate may comprise a cavity having an inlet and an outlet allowing a cooling fluid to circulate through the cavity. The end plate may comprise a base component defining a bottom surface and side walls of a recess, and a lid element adapted to cover an open side of the recess such that the base component and the lid together define the cavity.

In another aspect of the disclosure, there is provided a shielding sleeve for the inductor described herein, wherein the shielding sleeve comprises the opening covered by the filling material.

In another aspect of the disclosure, there is provided an end plate for the inductor described herein. The end plate comprises a cavity having an inlet and an outlet allowing a cooling fluid to circulate through the cavity. The end plate may comprise a base component defining a bottom surface and side walls of a recess, and a lid element adapted to cover an open side of the recess such that the base component and the lid together define the cavity.

According to this disclosure, there may be provided an inductor comprising a coil and an inductor core; wherein the inductor further comprises a tubular shielding sleeve surrounding the inductor core and where an inner surface of the sleeve is in contact with an outer surface of the inductor core.

As the shielding structure is a tubular sleeve it may be easily manufactured, e.g. from extrudable material like aluminum, as a separate component different from the inductor core for subsequently assembly with the inductor core. To this end, the sleeve may have a fixed cross-sectional profile along its axial length.

The inductor may easily be slid into place inside the sleeve while providing a snug fit between the circumferential surface of the inductor core and the sleeve. The tubular sleeve may surround the entire circumference (measured normal to the axial direction) of the inductor or only a major portion of the circumference, i.e. more than 50%, e.g. more than 75% such as more than 80%.

The sleeve may comprise heat dissipation structures extending from an outer surface of the sleeve. Thereby an improved cooling of the inductor is provided. The heat dissipation structures may be protrusions, ridges, fins, and/or the like.

The heat dissipation structures may extend in the axial direction of the sleeve. Thereby the shielding sleeve may be easily manufactured. The inductor core may have a cylindrical shape and the sleeve may comprise a hollow, cylindrical portion defined by a tubular wall from which the heat dissipating structures extend laterally. The heat dissipating structures may have respective lengths such that a cross section of the sleeve normal to the axial direction has a generally rectangular periphery. Consequently, the inductor has a rectangular footprint, thereby facilitating space-saving placement next to other components, e.g. other like inductors, while providing a large heat dissipating surface. Some or all of the heat dissipation structures may protrude radially from the outer surface. Alternatively or additionally, some heat dissipation structures may protrude in one or more different directions.

The outer surface of the sleeve may comprise a planar section defining a mounting surface, e.g. tangential to a tubular wall surrounding the inductor core. Thereby the sleeve facilitates an improved heat transfer away from the inductor through the mounting surface.

It is generally desirable that an inductor can be mounted in a flexible manner, e.g. to different cooling structures as e.g. on the inside of the wall of an apparatus housing with means of cooling on the outside. The cooling means could possibly be arranged as natural convection, forced airflow or liquid cooled structure.

Furthermore, in some applications it may be desirable to provide an efficient cable arrangement in the vicinity of the inductor, so as to avoid long wiring leading to/from the inductor, or so as to avoid the wiring to be in the vicinity of other components of a given installation.

The sleeve may comprise one or more mounting elements, which may extend axially. Thereby the inductor may be easily mounted while maintaining cost efficient manufacturing. For example, the axially extending mounting elements may comprise one or more axial channels for receiving a bolt, thus allowing mounting on a surface that is normal to the axis of the sleeve. Alternatively or additionally, the axially extending mounting elements may comprise one or more axially extending, laterally open channels, which may be used for mounting to a surface tangential relative to the sleeve, e.g. by means of self-cutting screws that may engage the channel walls. Yet alternatively or additionally, the sleeve may comprise mounting flanges on which the sleeve may rest and to which fastening elements such as clamps, screws or bolts may engage. To this end, the flanges may each define a contact surface and an outwardly directed edge. The contact surface of the flange may be parallel with a mounting surface of the sleeve.

The tubular sleeve has open ends at its respective axial ends. The inductor may further comprise one or more end plates each mountable to a respective one of the open ends of the tubular sleeve so as to close said end, thus providing additional magnetic shielding and/or additional heat dissipation surfaces. One or both of the end plates may comprise a cavity having an inlet and an outlet allowing a cooling fluid to circulate through the cavity. The cooling fluid may be any suitable cooling fluid, e.g. a cooling liquid such as water. Multiple inductors may be stacked along a common axis, e.g. with an end plate sandwiched between two neighbouring sleeves. The cavity may be shaped and sized such that it has a cross sectional shape in the axial direction substantially equal to or, optionally, slightly smaller or larger than the cross sectional shape and size of the inductor core.

The sleeve and/or the end plates may be made of a metal material such as aluminum or an aluminum alloy, or a ceramic such as silicon nitride, alumina, aluminum nitride, boron nitride, or silicon carbide. In particular, when the sleeve and/or the end plates is/are made from a non-magnetic but electrically conductive material such as aluminum, the sleeve and/or end plate(s) provide(s) an efficient shielding confining the magnetic field to the interior of the inductor. The sleeve may advantageously be manufactured from an extrudable material such as aluminum. It will be appreciated that, in some cases, only a portion of the shield facing the inductor core, is made of aluminum or a similar non-magnetic but electrically conductive material while a portion facing not directly in contact with the inductor core may be made from a different material e.g. plastic or another mouldable material.

The end plate may comprise a base component defining a bottom and side walls of a recess, and a lid element adapted to cover an open side of the recess such that the base component and the lid together define the cavity. The cavity may be shaped and sized such that it has a cross sectional shape in the axial direction substantially equal to or, optionally, slightly smaller or larger than the cross sectional shape and size of the inductor core. The lid may have a shape and size equal to the shape and size of the inductor core. The plate may be mounted with the lid facing the inductor core so as to provide a snug fit between the outer surface of the inductor core and the end plate. The end plate may be shaped and sized such that, when assembled with the sleeve, the lid slightly protrudes into the tubular sleeve. The base component may be made of any suitable material such as plastic. The lid may be made of a metallic material, e.g. aluminum, or similar material as described in relation to the sleeve.

The sleeve comprises an opening, e.g. in the form of an axially extending slot, thus allowing wires to/from the coil to be led through the sleeve. The slot may extend across the entire axial length of the sleeve. Thereby the tubular sleeve walls may be elastically bent outwards during insertion of the inductor core into the sleeve, thus providing a tight fit and close contact between the inductor core and the sleeve while allowing for an easy assembly. The opening may be filled with a filling material; the filling material may define an outer surface, e.g. a generally planar outer surface, for mounting the inductor to an external mounting surface. The outer surface may comprise a groove or other feature for attaching a gasket to the outer surface. Alternatively or additionally, the outer surface of the filling material may be provided with a protrusion operable as a gasket element. It will be appreciated that the provision of a filling material which fills the opening of a core and/or housing of an inductor and which provides an outer surface, optionally provided with a gasket, for mounting the inductor to a mounting surface may also be provided in connection with an inductor without a sleeve as described herein.

The sleeve may also, in addition to or as an alternative to the groove or other feature for attaching a gasket, be provided with an under-cut, or groove, in close proximity to the opening in order to tightly attaching a gasket.

The inductor may be of the pot core type. The inductor core may comprise an inner core portion surrounded by the coil and an outer core portion surrounding the coil and defining an outer surface of the inductor core. The inductor core comprises two separate inductor core components which, when assembled with each other, together form the inductor core and define a common axis.

Inductors as described herein may be manufactured in a variety of sizes. In case the inductor core components are made from compacted powder, the radial dimension of the inductor core may be between 30 mm and 300 mm, such as between 40 mm and 250 mm. The axial dimension of the inductor core may be below 300 mm, e.g. below 200 mm, e.g. below 100 mm.

The outer core portion may surround the entire circumference of the coil and the axial ends, or the outer core portion may surround a major portion of the circumference of the coil and/or the axial ends. The inductor core may comprise an inner core member and an outer core member, each axially extending between a first and a second base member and providing respective magnetic flux paths between the first end second base members; wherein the outer core member at least partly surrounds the inner core member, thereby defining an outer circumference of a space around the inner core member for accommodating a winding between the inner and the outer core members.

The inner core member may be formed as a cylindrical or a tubular structure or it may have a different cross-sectional shape, e.g. polygonal. The inner core member may be formed by respective first and second inner core members, each extending from a respective one of the first and second base members towards each other.

The first and second base members may be formed as respective plates, e.g. circular plates, where the inner core member axially extends from a center of the plates, and where the outer core member extends from a peripheral portion of the end plates, and where the base member provides a radial flux path connecting the inner and outer core members.

The assembled inductor core may have cylindrical shape having a circular cross-section. Alternatively, the inductor may have a different cross sectional shape, such as polygonal, e.g. hexagonal, rectangular, or the like. When the sleeve defines a tubular hollow shape corresponding to the cross-sectional shape of the inductor core, a snug fit of the sleeve around the inductor core is provided. When the inductor core as fixed cross-section over its entire length, the inductor core may easily slid into place inside the sleeve while being in contact with the inner surface of the sleeve over the entire length of the inductor.

The sleeve may have an axial length so as to completely accommodate the inductor core, i.e. to surround the inductor core along the entire axial length of the inductor core. The sleeve may be slightly longer than the inductor core, so as to allow a portion of one or more end plates to protrude into the open ends of the sleeve and to contact the end faces of the inductor core. It will be appreciated that the sleeve may be provided in various lengths. Hence, sleeves for accommodating various sizes of inductor cores may be provided and even sleeves that accommodate multiple inductor cores in axial extension to one another, optionally separated by shielding plates.

Embodiments of the inductor core described herein are well-suited for production by Powder Metallurgy (P/M) production methods. Accordingly, inductor core may be made from a soft magnetic material such as compacted soft magnetic powder, thereby simplifying the manufacturing of the inductor core components and providing an effective three-dimensional flux path in the soft magnetic material allowing e.g. radial, axial and circumferential flux path components in an inductor core. Here and in the following, the term soft magnetic is intended to refer to a material property of a material that can be magnetized but does not tend to stay magnetized, when the magnetising field is removed. Generally a material may be described as soft magnetic when its coercivity is no larger than 1 kA/m (see e.g. “Introduction to Magnetism and Magnetic materials”, David Jiles, First Edition 1991 ISBN 0 412 38630 5 (HB), page 74).

The term “soft magnetic composites” (SMC) as used herein is intended to refer to pressed/compacted and heat-treated metal powder components with three-dimensional (3D) magnetic properties. SMC components are typically composed of surface-insulated iron powder particles that are compacted to form uniform isotropic components that may have complex shapes in a single step.

The soft magnetic powder may e.g. be a soft magnetic Iron powder or powder containing Co or Ni or alloys containing parts of the same. The soft magnetic powder may be a substantially pure water atomised iron powder or a sponge iron powder having irregular shaped particles which have been coated with an electrical insulation. In this context the term “substantially pure” means that the powder should be substantially free from inclusions and that the amount of the impurities such as O, C and N should be kept at a minimum. The weight-based average particle sizes may generally be below 300 μm and above 10 μm.

However, any soft magnetic metal powder or metal alloy powder may be used as long as the soft magnetic properties are sufficient and that the powder is suitable for die compaction.

The electrical insulation of the powder particles may be made of an inorganic material. Especially suitable are the type of insulation disclosed in U.S. Pat. No. 6,348,265 (which is hereby incorporated by reference), which concerns particles of a base powder consisting of essentially pure iron having an insulating oxygen- and phosphorus-containing barrier. Powders having insulated particles are available as Somaloy® 500, Somaloy® 550 or Somaloy® 700 available from Höganas AB, Sweden.

Moreover, the modular design of the inductor further enables the manufacturing of multiple versions of an inductor from only a limited number of components, e.g. inductors that are mounted with their axis normal to a mounting surface, inductors for mounting with their axis parallel to a mounting surface, inductors with or without one or more end plates, inductors with one or more end plates that are cooled by a cooling fluid, etc.

The present disclosure relates to different aspects including the inductor described above and in the following, corresponding methods, devices, and/or product means, each yielding one or more of the benefits and advantages described in connection with the first mentioned aspect, and each having one or more embodiments corresponding to the embodiments described in connection with the first mentioned aspect and/or disclosed in the appended claims.

In particular, disclosed herein are embodiments of a shield/housing for an inductor, the inductor comprising a coil and an inductor core; wherein the shield/housing comprises a tubular shielding sleeve sized and shaped to surround the inductor core where an inner surface of the sleeve is in contact with an outer surface of the inductor core.

According to another aspect, disclosed herein are embodiments of an end plate for a shielding structure of an inductor, the inductor comprising a coil and an inductor core, the shielding structure surrounding the inductor core and defining at least one opening for receiving the inductor core, wherein the end plate comprises a cavity having an inlet and an outlet for accommodating and circulating a cooling fluid through the cavity. In particular, the end plate may comprise a base component defining a bottom surface and side walls of a recess, and a lid element adapted to cover an open side of the recess such that the base component and the lid together define the cavity.

### BRIEF DESCRIPTION OF THE DRAWINGS

Embodiments of the various aspects disclosed herein, as well as additional objects, features and advantages of the present inventive concept, will be described in more detail in the following illustrative and non-limiting description of embodiments of the aspects disclosed herein with reference to the appended drawings, where like reference numerals refer to like elements unless stated otherwise, wherein:

FIG. 1 shows a schematic cross-sectional view of an embodiment of an inductor.

FIG. 2 shows a three-dimensional view of an embodiment of inductor.

FIG. 3 shows a tubular shielding structure for an inductor.

FIG. 4 illustrates examples of an embodiment of an inductor mounted on a base plate.

FIG. 5 shows another embodiment of inductor.

FIG. 6 shows another embodiment of inductor.

FIG. 7 shows an embodiment of an end plate for a shielding structure for an inductor.

FIGS. 8A-D show yet another embodiment of an inductor.

FIGS. 9A and 9B show yet another embodiment of an inductor.

FIG. 10 shows an embodiment of an under-cut, or groove, in close proximity to the opening.

FIG. 11 shows an inductor core.

### DETAILED DESCRIPTION OF PREFERRED EMBODIMENTS

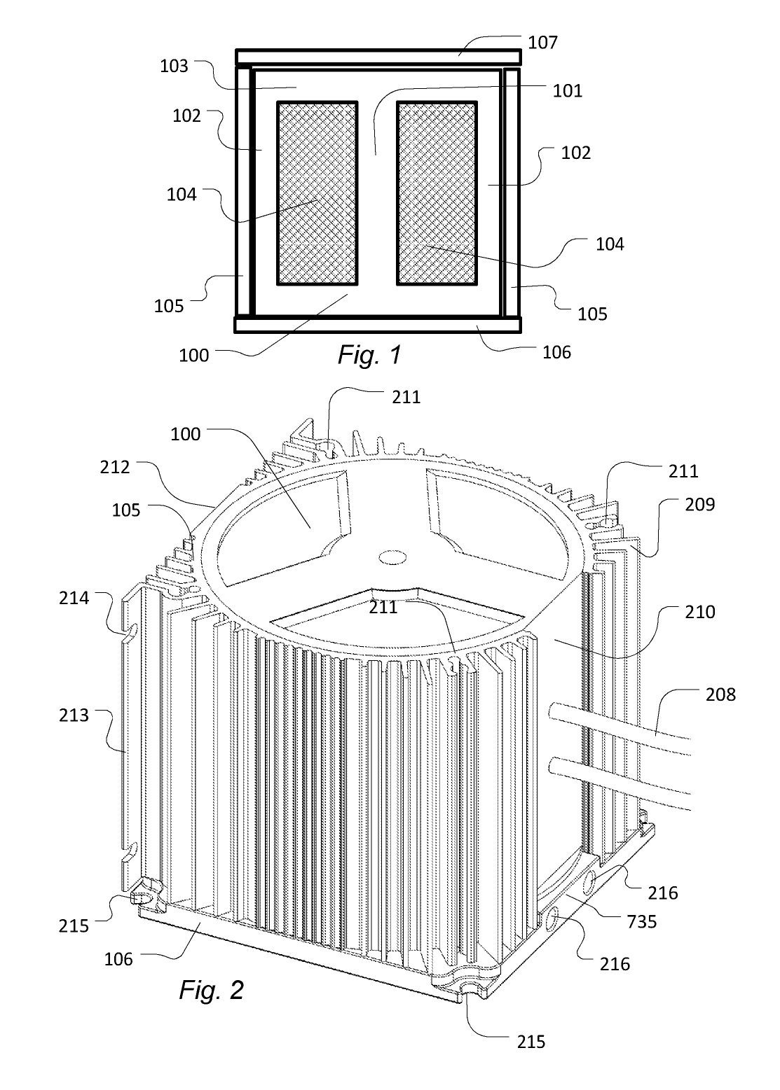

FIG. 1 shows a schematic cross-sectional view of an embodiment of an inductor. The inductor comprises an inductor core 100 and a coil 104. The inductor core 100 comprises an inner portion 101 around which the coil 104 is wound. The inner portion may be an axially extending rod having circular cross-section or a cross-section of a different shape. The inductor core further comprises an outer portion surrounding the coil 104. In this example, the outer portion comprises a tubular outer portion 102 and plate-like end portions 103 connecting the outer tubular portion 102 with the inner portion 101. The tubular outer portion is coaxial with the inner portion. The inner portion and the outer portion define a hollow space having annular cross section for accommodating the coil. The inductor core may be manufactured from multiple components, e.g. from two cup shaped halves where each half has a central rod protruding from the bottom of the cup. The two halves may be assembled axially aligned and with their respective central rods facing each other. It will be appreciated that, in alternative embodiments, the shape and/or arrangement of the inductor core and/or the coil may be different.

The coil 104 has a tubular shape and is sized such that it surrounds the inner core portion and fits in the space between the inner and outer core portions. The inductor core further comprises a winding lead-through and/or other features (not shown so as to simplify the illustration). The lead-through may be arranged e.g. in the tubular outer core portion 102 or in one of the end portions 103.

The inductor core may be made of compacted magnetic powder material. The material may be soft magnetic powder. The material may be ferrite powder. The material may be surface-insulated soft magnetic powder, e.g. comprising iron particles provided with an electrically insulating coating. The resistivity of the material may be such that eddy currents are substantially suppressed. As a more specific example, the material may be a soft magnetic powder, e.g. from the product family Somaloy (e.g. Somaloy® 110i, Somaloy® 130i or Somaly® 700HR) from Hoeganaes AB, S-263 83 Hoeganaes, Sweden.

Alternatively, the inductor core, or parts thereof, may be made from a different material of a sufficiently high permeability, higher than the permeability of air, and/or assembled from a plurality of individual pieces rather than formed in a single piece.

The inductor further comprises a shielding structure or housing comprising a tubular sleeve 105 and end plates 106 and 107, respectively. The shielding structure surrounds the stator core 100 so as to reduce the magnetic field outside of the inductor. To this end, the shielding structure is made from a non-magnetic but electrically conductive material, e.g. a material having a relative permeability smaller than 2 such as aluminum or an aluminum alloy.

The sleeve 105 has a shape and size so as to snuggly fit around the inductor core. The sleeve 105 is open at both ends. In the example of FIG. 1, the open ends of the sleeve are closed by end plates 106 and 107, respectively.

FIG. 2 shows another embodiment of an inductor. The inductor comprises an inductor core 100 and a coil (not shown). The inductor core 100 and the coil may be of the type described in connection with FIG. 1. The inductor further comprises a shielding structure comprising a tubular sleeve 105 and an end plate 106.

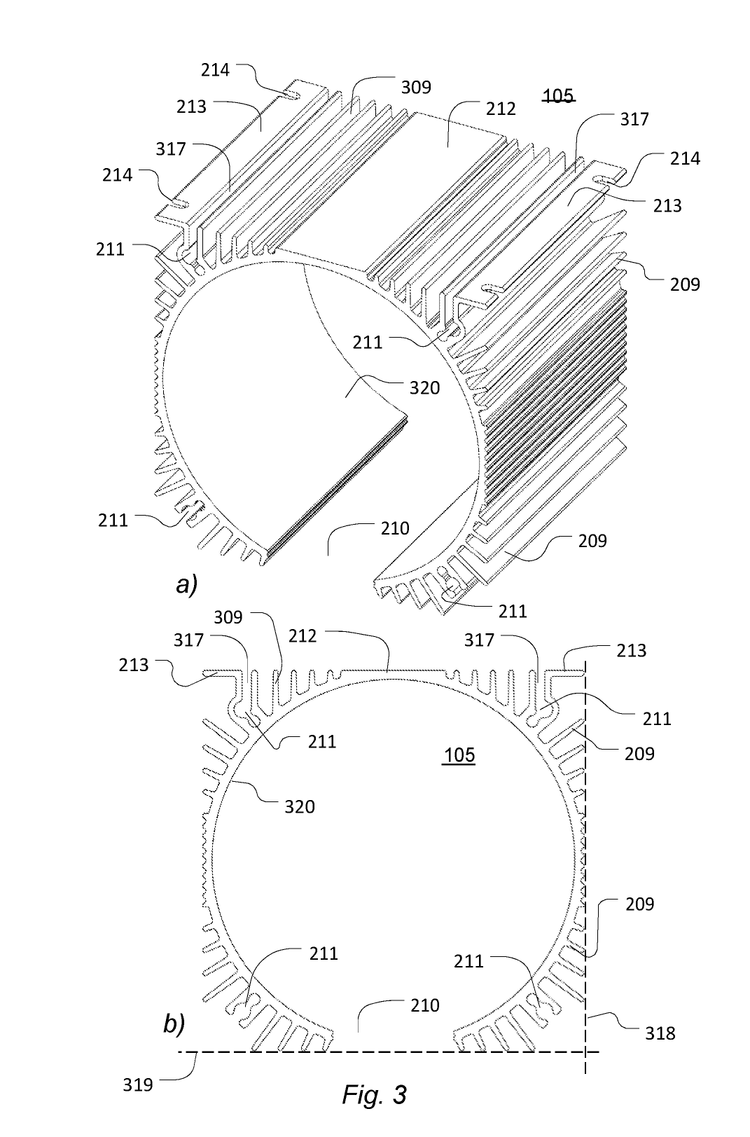

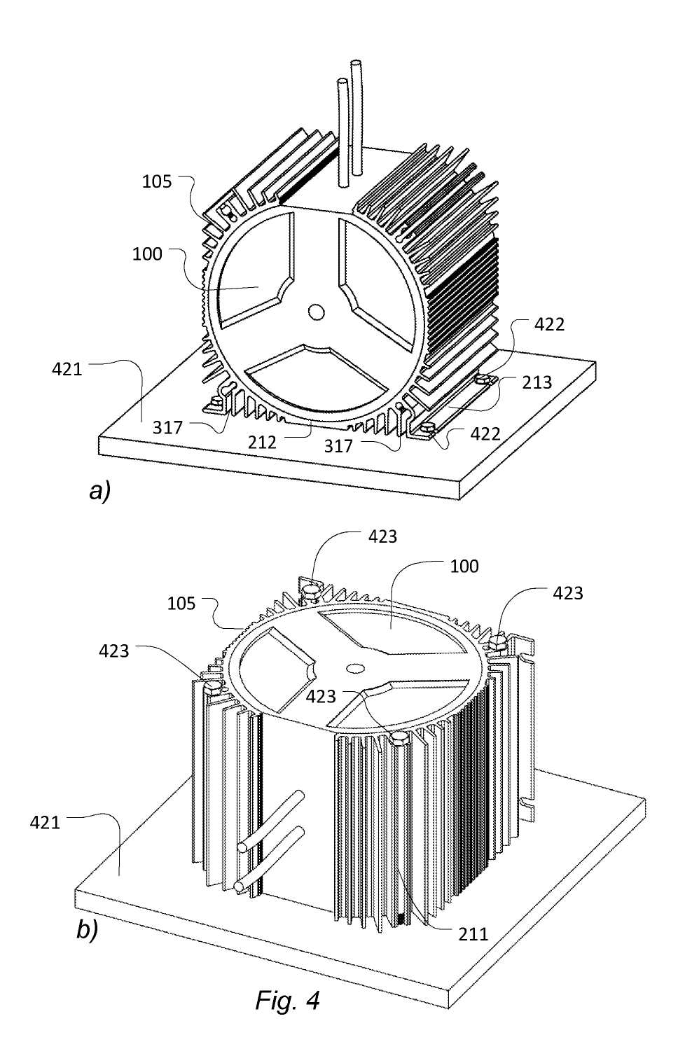

FIG. 3 shows a more detailed view of the tubular sleeve 105. In particular, FIG. 3a shows a three-dimensional view of the sleeve 105 while FIG. 3b shows a top view of the sleeve seen in the axial direction. Referring to FIG. 3 with continued reference to FIG. 2, the tubular sleeve 105 comprises a tubular wall having an inner contact surface 320 defining an inner hollow space for accommodating the inductor core 100. In this example, the inner core 100 has cylindrical shape and, thus, the sleeve 105 has a cylindrical inner contact surface 320, shaped and sized so as to be in contact with the inductor core. The sleeve comprises heat dissipation structures 209 and 309 outwardly protruding from the tubular wall. Consequently, the sleeve 105 allows heat from the inductor to be efficiently dissipated. In this example, the heat dissipation structures are axially extending fins. They have different lengths so as to give the sleeve a cross-sectional profile that may snugly be inscribed in a rectangle, as indicated in FIG. 3b by lines 318 and 319. Consequently, the inductor may easily be arranged in close proximity to other components and, in particular, other like inductors, in a space-saving manner.

As in the example of FIG. 1, the shielding structure of FIG. 3 is made from a non-magnetic but electrically conductive material, e.g. a material having a relative permeability smaller than 2 such as aluminum or an aluminum alloy. The sleeve has a fixed cross-sectional profile, thus allowing efficient production of the sleeve, e.g. by an extrusion process. The sleeve is made from aluminum. It will be understood, however, that other materials may be used.

The sleeve comprises a number of mounting structures allowing the assembled inductor to be mounted in different orientations, e.g. as illustrated in FIG. 4 for an inductor as in FIG. 2 but without end plate. It will be appreciated that the inductor of FIG. 2 including an end plate or an inductor comprising two end plates, one at each end, may be mounted in the same fashion.

In particular, the sleeve comprises a planar mounting surface 212 tangential to the tubular wall surrounding the inductor core. Consequently, as illustrated in FIG. 4a, the inductor may be positioned on a support surface 421 with the mounting surface 212 facing the support surface 421. The mounting surface thus facilitates heat to be efficiently exchanged between the sleeve and the mounting surface, and led away from the inductor by the support surface.

The sleeve further comprises axially extending L-shaped flanges 213 that provide a contact surface parallel with the mounting surface 212 and outwardly oriented edges. Hence, when the inductor rests with its mounting surface 212 on a planar support 421, the contact surface of the flanges 213 are also in contact with the support 421 and allow the inductor to be secured to the support 421 via clamps or via screws or bolts 422 extending through cut-outs 214 or through holes in the flanges as illustrated in FIG. 4a. The flanges 213 are provided on both sides of the mounting surface so as to provide a stable support and easy mounting. The heat dissipation features 309 between the flanges 213 and the support surface 212 have a length such that their edges are aligned with the mounting surface. Moreover the dissipation features between the flanges 213 and the mounting surface extend from the tubular sleeve wall in a direction normal to the mounting surface 212. Hence, the mounting surface, the flanges 213 and the edges of the dissipation features 309 between them together form a stable, planar support.

Each flange and an adjacent one of the heat dissipation features define a channel 317 that is open in the direction away from and normal to the mounting surface 212. Hence, the inductor may be mounted onto a support plate 421 by driving a self-cutting screw into the channel 317 from below.

The sleeve further facilitates mounting of the assembled inductor as illustrated in FIG. 4b, i.e. with its axis normal to the mounting surface 421. To this end, the sleeve comprises mounting features radially extending outward from the tubular sleeve wall and defining an axial channel 211 for receiving a bolt 423 or a screw or a similar fastening element.

Hence, the inductor may be mounted in alternative orientations without the need for reassembly of the inductor core within the sleeve. Moreover, the mounting features forming the channels 211, the flanges 213 and the mounting surface also contribute to the heat dissipation.

The sleeve 105 has a shape and size so as to snuggly fit around the inductor core. The sleeve 105 is open at both ends and allows easy assembly.

The sleeve 105 comprises an axially extending slot 210 thus allowing wires from the coil to be fed through the sleeve. Furthermore, the slot allows the tubular wall to be slightly pressed outwards so as to easily slide the inductor core into place.

Again referring to FIG. 2, the end plate 106 is mountable to the end of the sleeve by bolts or screws, by gluing or in another suitable way. The end plate comprises mounting holes 215 at its corners providing yet another option for mounting the assembled inductor to a support plate. The end plate covers the entire opening of the sleeve. As will be described in greater detail below, the end plate may comprise a cavity for receiving and circulating a cooling fluid. To this end, a side face of the end plate comprises input and output ports 216 in fluid communication with the cavity so as to allow cooling fluid to be circulated through the cavity.

The inductor of FIG. 2 comprises only one end plate covering one of the open ends of the sleeve. However, it will be appreciated that, in other embodiments, both open ends may be covered by a respective end plate. Similarly, in yet other embodiments, the inductor may only have a sleeve with without any of the open ends being covered by any end plate, e.g. as in the example of FIG. 4.

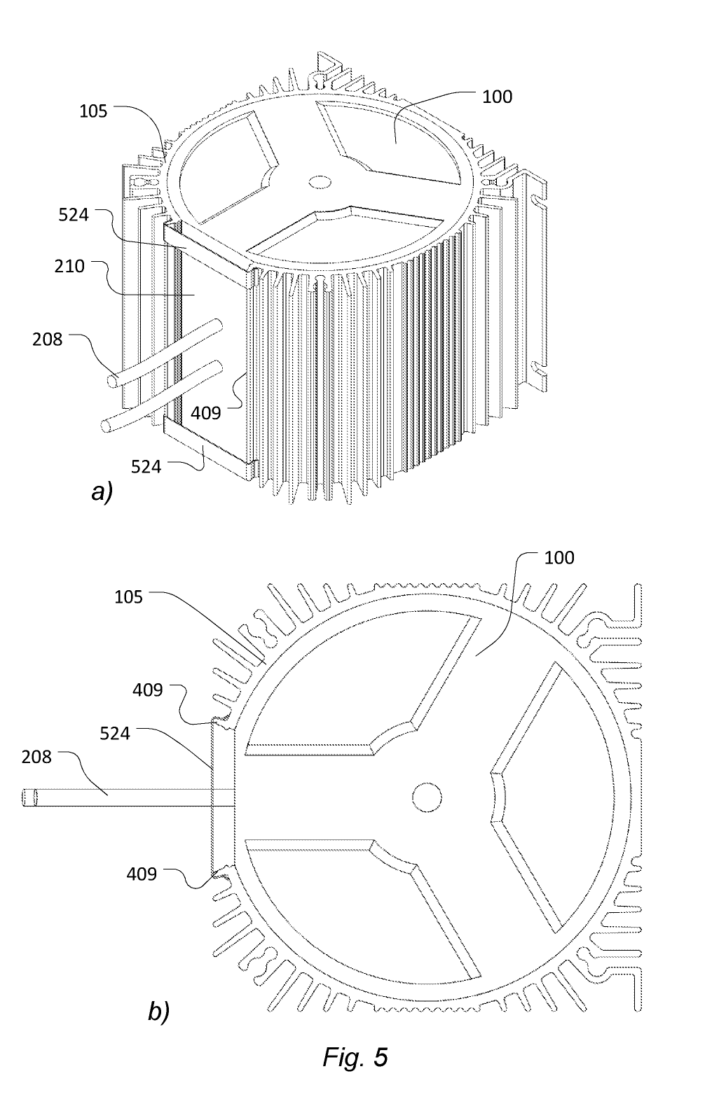

FIG. 5 shows another example of an inductor. In particular, FIG. 5a shows a three-dimensional view of the inductor, while FIG. 5b shows a top view seen from the axial direction. The inductor of FIG. 5 is similar to the inductor of FIG. 4 in that it comprises an inductor core 100, a coil (not shown), and a sleeve 105, e.g. a sleeve as described in connection with FIG. 3. As described above, the sleeve 105 is provided with an axially extending slot 210 allowing the wires 208 to be fed out from the coil, and allowing the tubular walls to be spread slightly apart when sliding the inductor core into place. Once the inductor is assembled it may be desirable, in particular in embodiments without end plates, to secure the tubular walls against being spread apart, as this may cause the inductor to slide out of the sleeve. To this end, the tubular walls may be pulled towards each other by one or more clamp members 524, e.g. a resilient clamp member that may be snapped onto and engage the heat dissipation features 409 on either side of the slot 210. Alternatively or additionally, the sleeve may be attached to the inductor core by glue or other suitable fastening means.

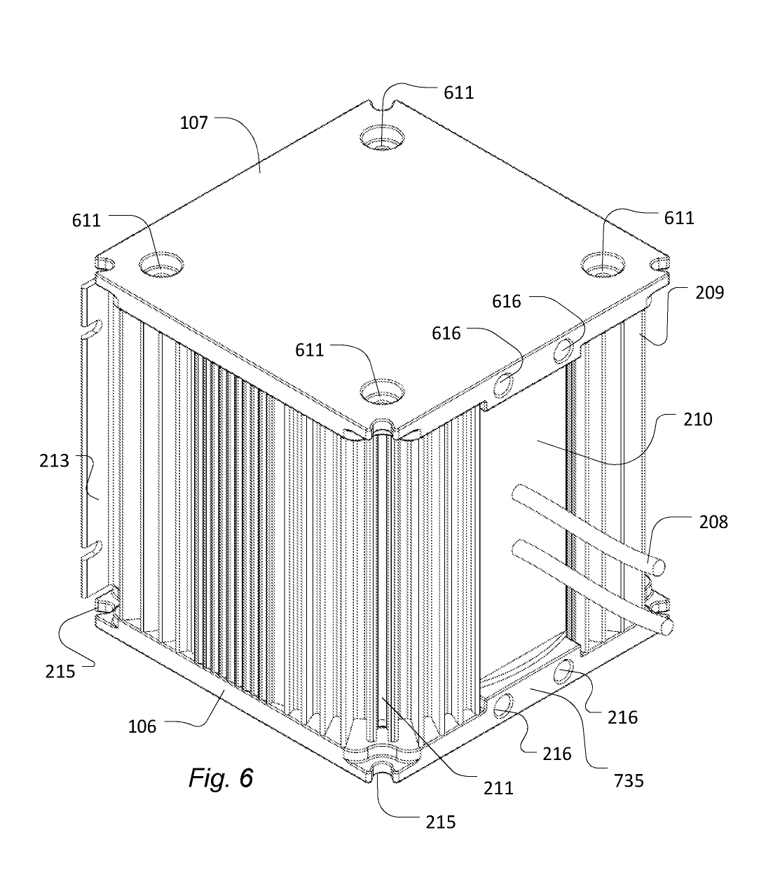

FIG. 6 shows yet another embodiment of an inductor. The inductor of FIG. 6 is similar to the inductor in FIG. 2 except that it comprises two end plates 106 and 107, respectively, each covering a respective one of the open ends of the sleeve 105. In the example of FIG. 6, the end plates 106 and 107 are identical to each other, i.e. also the end plate 107 comprises input/output ports 616 in fluid communication with a cavity inside the end plate. End plate 107 comprises through holes 611 that are aligned with the channels 211, thus still allowing the inductor to be easily mounted with its axis vertical to the supporting surface to which it is mounted. It is understood that end plate 106 comprises corresponding holes.

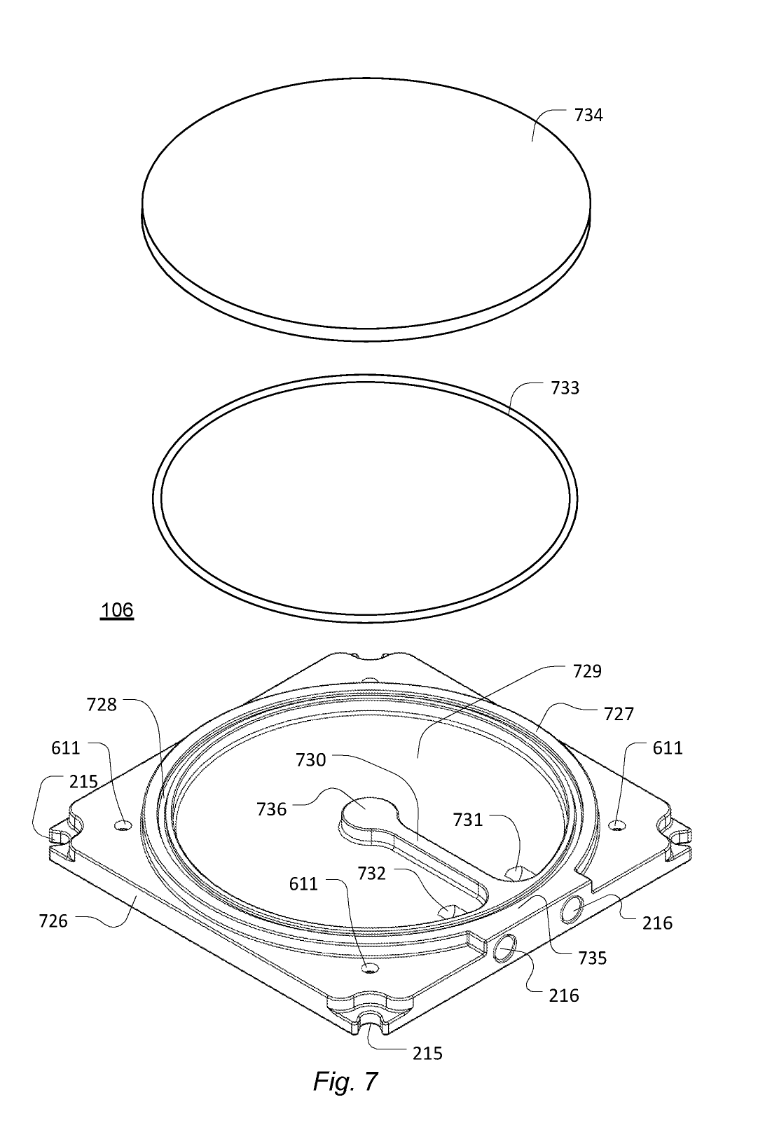

FIG. 7 shows an exploded view of an example of an end plate for an inductor, e.g. end plate 106 of FIG. 2 or FIG. 6. The end plate 106 comprises a base plate 726 comprising a circular ridge 727 defining a recess. The ridge comprises a channel at its radially inner circumference for receiving a sealing ring 733. The end plate further comprises a lid 734 shaped and sized to be placed on the ridge thus so as to define a cavity 729 between the base plate 726 and the lid 734, delimited by the ridge 727. The lid may be secured to the ridge by gluing or by other suitable means. Hence, the ridge and lid slightly protrude from the base plate.

The cavity 729 comprises an inlet 731 and an outlet 732 each in fluid communication with a respective one of the ports 216 at an edge of the base plate 726. The base plate comprises a radial ridge 730 extending from the centre of the cavity to a position at the periphery of the cavity between the inlet 731 and the outlet 732, thus causing cooling fluid entering the cavity through the inlet 731 to flow around the ridge 730 towards the outlet 732. Hence fluid flow is ensured through the entire cavity. The central end 736 of the ridge is formed as a cylindrical protrusion on which the centre of the lid may rest, thus preventing the lid from being bent inwards.

The channels connecting the inlet 731 and outlet 732 with the respective ports 216 are accommodated in a part 735 of the base plate that has an increased height, corresponding to the height of the ridge 727. The increased height portion 735 extends from an outer periphery of the ridge 727 to the edge of the base plate. It will be appreciated, however, that other cavity designs resulting in a fluid flow between an inlet and an outlet, e.g. a meandering flow, may be provided.

The assembled end plate is mounted onto the sleeve with the lid 734 facing towards the inductor core. In particular, as most easily seen in FIG. 6, the ridge 727 and the lid 734 are shaped and sized such that they protrude into the opening of the sleeve such that the lid is in contact with the inductor core and the edge of the base plate rests on the edge of the sleeve. The portion 735 also extends into the sleeve and is sized and shaped such that its edge portion with the ports 216 fits into the axial slot 210, thus providing a compact design, easy access to the ports 216, and simple assembly where the portion 735 functions as an indexing feature facilitating alignment of the end plate.

The end plate may then be secured to the sleeve by bolts through holes 611, by gluing or other suitable attachment means. Consequently, the lid 734 is in contact with the inductor core allowing an efficient heat exchange between the inductor core and the cooling fluid. When the end plate is secured to the sleeve by bolts or similar attachment means, the lid is further pushed against the seal 733, thus preventing leakage of the cooling fluid. Moreover, when the lid 734 is made of aluminum or another suitable material as described in connection with the sleeve, an efficient shielding of the magnetic field is provided. The base plate 726 may also be made from aluminum or another material shielding the magnetic field. Alternatively, the base plate 726 may be made from plastic or other suitable material allowing easy manufacturing, e.g. by an injection moulding process. This allows a cost-efficient manufacturing of the end plate, while maintaining efficient cooling and shielding by the lid.

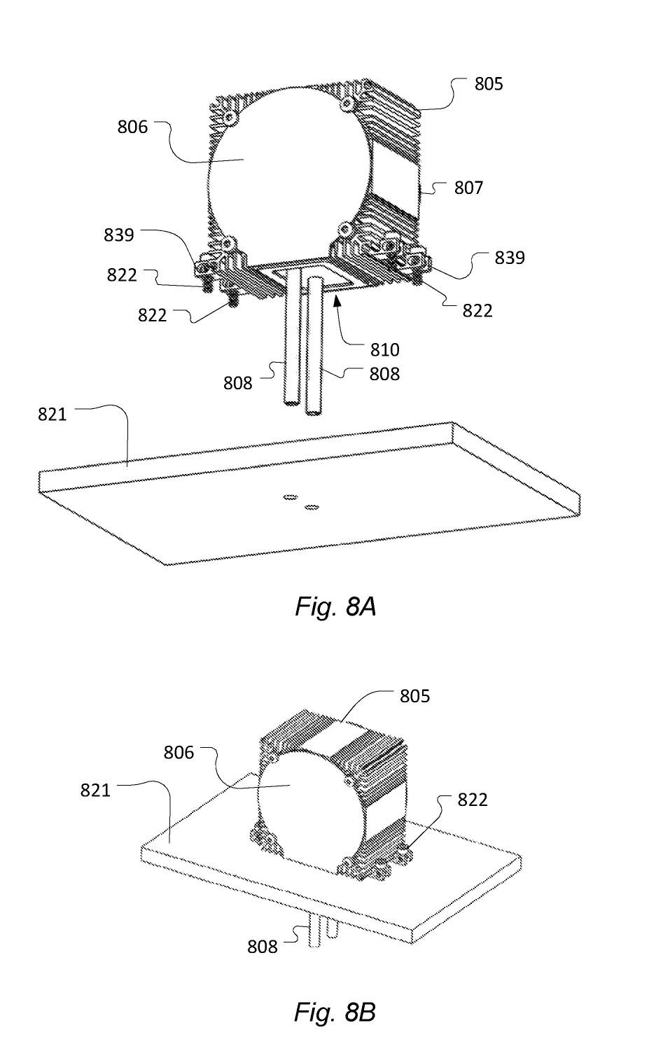

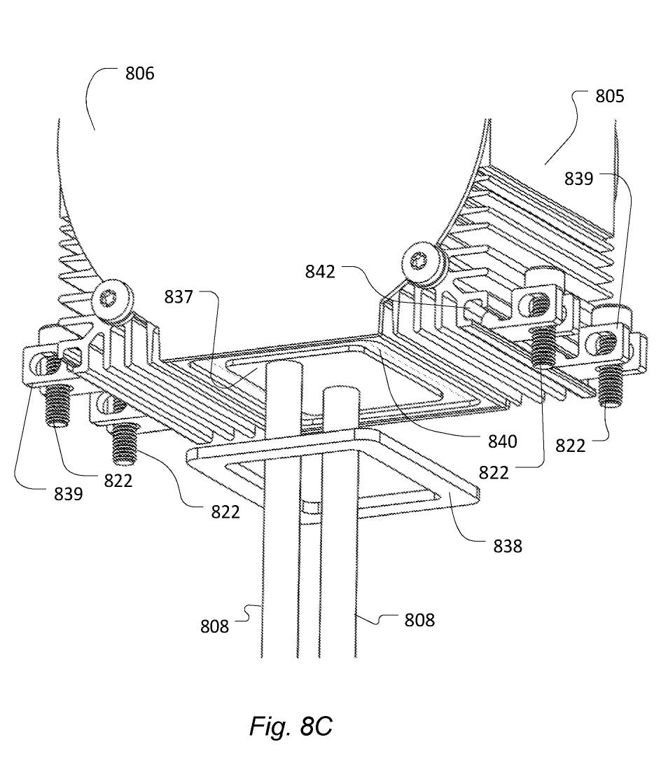

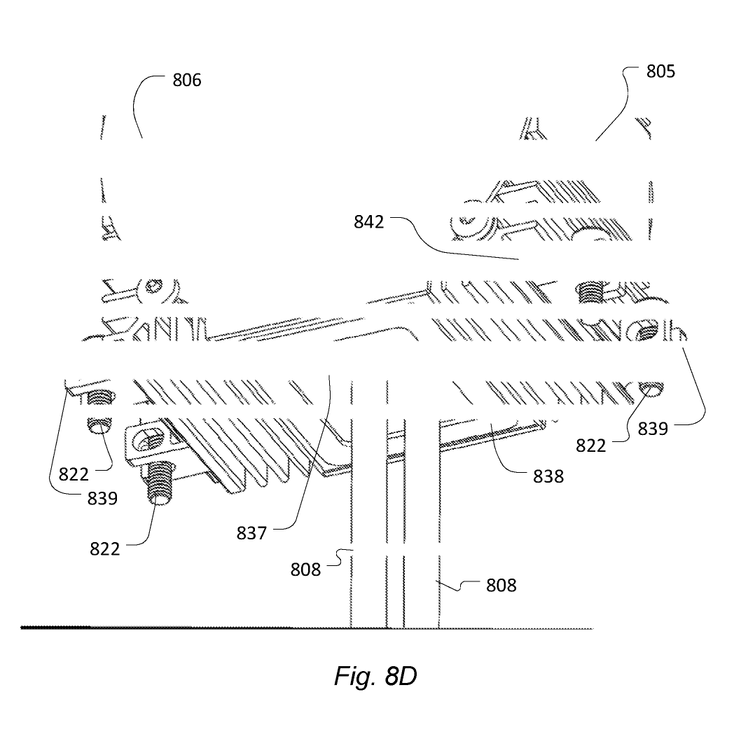

FIGS. 8A-D show yet another embodiment of an inductor, where FIG. 8A shows the assembled inductor prior to mounting on a mounting surface, FIG. 8B shows the assembled inductor mounted on a mounting surface, FIG. 8C shows a partial view of the assembled inductor with sealing gasket removed, and FIG. 8D shows a partial view of the assembled inductor sealing gasket located in the intended place. The inductor of FIGS. 8A-D is similar to the inductor of FIG. 2 in that it comprises a shielding sleeve 805 as described herein and two end plates 806 and 807, respectively, each covering a respective one of the open ends of the sleeve 805. The sleeve 805 defines an opening through which wires 808 are fed. In the example of FIGS. 8A-D, the opening is in the form of an axial slot 810, e.g. as described in connection with the embodiment of FIG. 2. As illustrated in FIGS. 8A-D, the opening 810 is filled with a filling material 837, e.g. rubber, silicone, polyurethane or another suitable material. The filling material may be a pliable, elastic element which may be press-fit into the opening and/or into a channel/groove between heat dissipating features which may even be provided with a mounting feature for securing the filling material. Alternatively, the material may be a curable material which is filled into the opening and then cured. Such material may even be provided so as to fill all voids between the inductor components inside the sleeve so as to reduce the effect of vibrations. In any event, the filling material defines a surface substantially aligned with a mounting surface defined by the sleeve (e.g. as described in connection with FIG. 3) for mounting on an external mounting surface 821 such that the filling material 807 faces the mounting surface 821.

In the present example, the outer surface of the filling material is provided with a recess/groove 840 for receiving a gasket 838 which circumferentially surrounds the wires 808. FIG. 8C illustrates the filling material with the gasket 838 removed in order to show the recess/groove 840, while FIG. 8D illustrates the gasket located in the recess/groove 840. Consequently, when the inductor is mounted on a surface 821 with the filling material facing the mounting surface 821, the gasket 838 defines a tightly sealing connection with the mounting surface 821, thus protecting the ducts through which the wires 808 extend from humidity. This is particularly desirable when the inductor is to be mounted without further shielding housing e.g. on an outside surface of a housing which accommodates other electronic components.

Alternatively or additionally, the outer surface of the filling material 837 may itself function as a sealing element, e.g. utilizing its elastic properties. The outer surface of the filling material 837 may be provided with a protrusion. Yet alternatively, the outer surface of the filling material may be planar and the gasket may be placed between the mounting surface 821 and the outer surface of the filling material 837.

In the present example, the inductor is mountable to the surface 821 by screws 822 fed through brackets 839 which are insertable into respective channels 842 defined between two axially extending heat dissipating features.

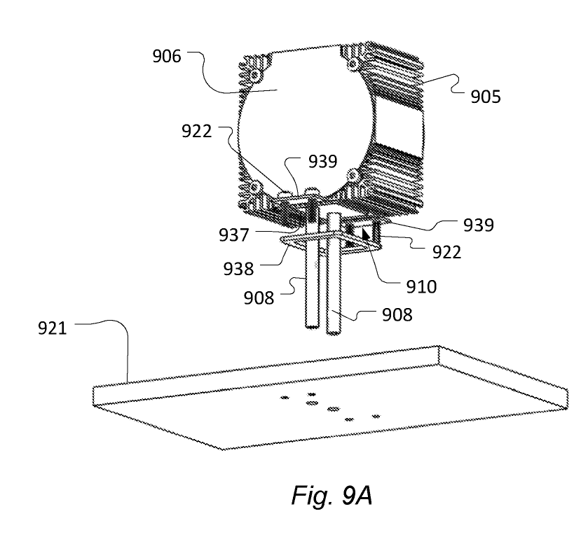

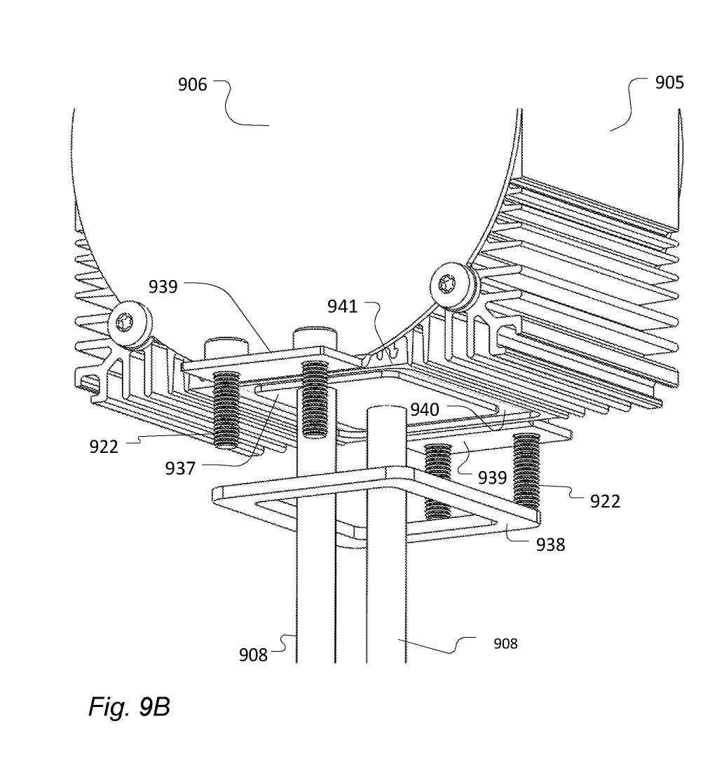

FIGS. 9A and 9B show yet another embodiment of an inductor. The inductor of FIGS. 9A-B is similar to the inductor of FIGS. 8A-D in that it comprises a shielding sleeve 905 and two end plates 906 and 907, respectively. The sleeve 905 defines an opening 910 through which wires 908 are fed, wherein the opening 910 is filled with a filling material 937 comprising a groove 940 for accommodating a gasket 938, all as described in connection with FIGS. 8A-D. In the present example, the inductor is mountable to the surface 921 by screws 922 extending through respective flanges 939 provided at the respective end plates 906 and 907. As can most easily be seen in FIG. 9B, the filling material may extend into one or more channels between adjacent heat dissipating features which may even be provided with a flange or lip 941 for further securing the filling material.

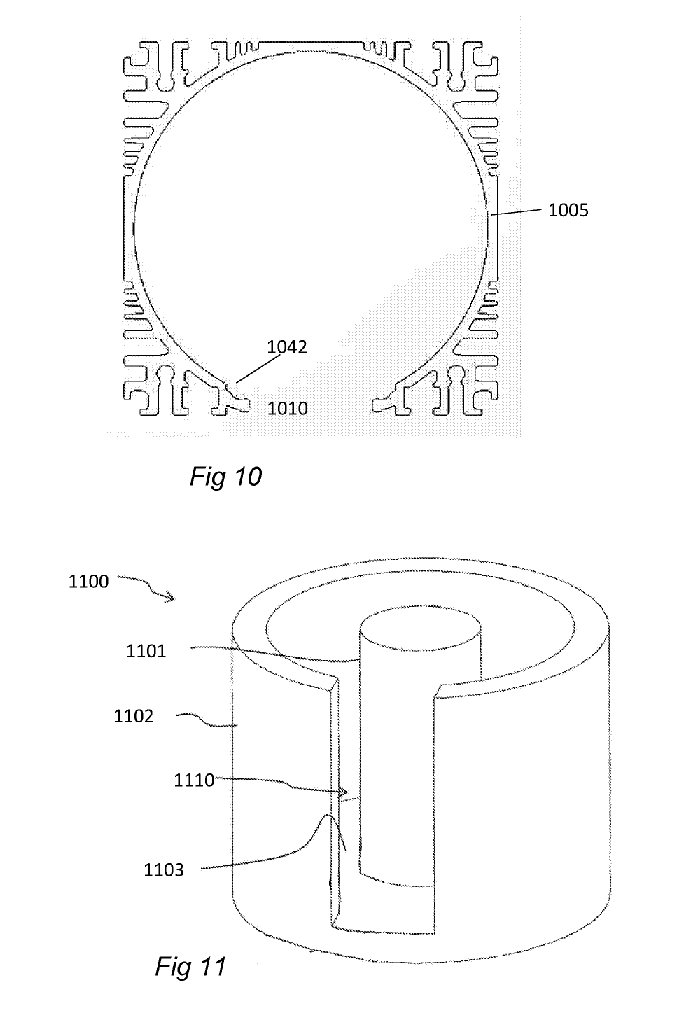

FIG. 10 illustrates an axial cross-section through a portion of a shielding sleeve 1005. The sleeve 1005 comprises an opening 1010, corresponding to the openings 210, 810, 910 described above in conjunction with FIGS. 2, 8 and 9. Adjacent to the opening 1010, the wall of the sleeve 1005 comprises an under-cut or groove 1042, which is adapted to receive a gasket, not illustrated. The under-cut or groove 1042 may surround the opening 1010, or in case the opening extends over the entire axial length of the sleeve 1005, there may be an under-cut or groove 1042 at either side of the opening, as is illustrated in FIG. 10. This gasket may be utilized as an alternative to, or complement to, utilizing the gasket 938 described in conjunction with FIG. 9 or to the utilizing the filling material itself as a gasket. When the sleeve 1005 forms part of the inductor, the opening 1010 is covered by a filling material, e.g. as described above in conjunction with FIGS. 8 and 9.

FIG. 11 illustrates an inductor core 1100. The inductor core 1100 comprises an end portion 1103 from which an outer portion 1102 and an inner portion 1101 extend in an axial direction. The winding of the coil, left out for simplicity, may be arranged around the inner portion 1101. The outer portion 1102 includes an axially extending slot 1110 forming an opening allowing wires, not illustrated, to go to/from the coil for connecting the winding to electrical components exterior of the inductor core 1100. The purpose of the opening 1110 is to provide a lead-through for the connection portion of the winding through the outer portion 1102. In order to provide an inductor, the coil is located in the inductor core 1100 in a corresponding way as described for FIG. 1 above. Further, the slot 1110 is covered with filling material except for where the wires pass, such that a tight seal is provided. The inductor core 1100 may be used together with a shielding sleeve, e.g. any one of the sleeves described herein, or the inductor core 1100 may be used without a sleeve.

Although some embodiments have been described and shown in detail, the invention is not restricted to them, but may also be embodied in other ways within the scope of the subject matter defined in the following claims. In particular, it is to be understood that other embodiments may be utilised, and that structural and functional modifications may be made without departing from the scope of the present invention. For example, in the above, inductor cores presenting a cylindrical geometry have been disclosed. However, the inventive concept is not limited to this geometry. For example, the inductor cores may present an oval, triangular, square or polygonal cross section.

Embodiments of the inductor described herein may be used in a variety of applications including photovoltaic applications, in power conversion units, voltage control units, filter units such as LC or LCL filters, etc. Embodiments of the inductor described herein may be used in systems operating at a variety of power levels, e.g. larger than 500 W such as larger than 1 kW, at a variety of frequencies including, but not limited to frequencies between 2 kHz and 30 kHz such as between 5 kHz and 25 kHz.

In device claims enumerating several means, several of these means can be embodied by one and the same structural component. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. An inductor comprising a coil and a side wall, the side wall surrounding the coil, the side all comprising an outer portion of an inductor core and/or a shielding sleeve, the side wall comprising an opening providing a passage of an electrical connection of the coil, wherein the opening is covered by a filling material, which fills the opening except for where the electrical connection passes.

2. The inductor according to claim 1, wherein the opening comprised in the side wall comprises, or consists of, a slot extending in an axial direction of the side wall.

3. The inductor according to claim 2, wherein the slot extends along a length corresponding to at least 50% of an axial length of the side wall.

4. The inductor according to claim 1, wherein the filling material is elastic.

5. The inductor according to claim 1, wherein the filling material comprises a polymer or a mixture of polymers.

6. The inductor according to claim 1, wherein the filling material is a pliable, elastic element adapted to be press-fit into the opening.

7. The inductor according to claim 1, wherein the filling material is a curable material, which is filled into the opening and then cured.

8. The inductor according to claim 1, wherein the filling material defines a generally planar outer surface.

9. The inductor according to claim 1, wherein the outer surface of the filling material comprises a groove or other feature for receiving a gasket.

10. The inductor according to claim 1, the inductor comprising the inductor core and the sleeve, wherein the sleeve surrounds the inductor core.

11. The inductor according to claim 1, the inductor comprises the sleeve, wherein the sleeve comprises heat dissipation structures extending from an outer surface of the sleeve.

12. The inductor according to claim 11, wherein the heat dissipation structures extend in an axial direction of the sleeve.

13. The inductor according to claim 1, wherein an outer surface of the side wall comprises a planar section defining a mounting surface.

14. The inductor according to claim 1, wherein the side wall comprises one or more mounting elements for mounting the inductor to an external object.

15. The inductor according to claim 14, wherein the mounting elements comprise one or more axial channels for receiving a bolt.

16. The inductor according to claim 14, wherein the mounting elements comprise one or more axially extending, laterally open channels.

17. The inductor according to claim 1, the sleeve comprising the opening, wherein the sleeve comprises at least one under-cut or groove for receiving a gasket.

18. The inductor according to claim 1, the side wall comprising the sleeve, wherein the inductor comprises at least one end plate mountable to an end of the sleeve so as to close said end, wherein the end plate comprises a cavity having an inlet and an outlet allowing a cooling fluid to circulate through the cavity.

19. The inductor according to claim 18, wherein the end plate comprises a base component defining a bottom surface and side walls of a recess, and a lid element adapted to cover an open side of the recess such that the base component and the lid together define the cavity.

20. A shielding sleeve for the inductor according to claim 1, wherein the sleeve comprises the opening covered by the filling material.
